(19) United States
(12) Patent Application Publication
(10) Pub. No.: US 2012/0148800 A1
(43) Pub. Date: Jun. 14, 2012

(54) STRIP OF A WIPING MATERIAL, AND APPARATUS FOR DISPENSING SAME FOR HAND-WIPING, ALL-PURPOSE WIPE, AND OTHER HYGIENIC USES

(76) Inventor: Maurice Granger, Saint Priest En Jarez (FR)

(21) Appl. No.: 13/387,876

(22) PCT Filed: Jul. 30, 2010
(86) PCT No.: PCT/FR10/51635

§ 371 Date: Feb. 28, 2012

(30) Foreign Application Priority Data
Aug. 4, 2009 (FR) 0955465

(51) Int. Cl. B32B 3/00; B65H 18/28; B65H 20/02; A47K 10/44

(52) U.S. Cl. 428/156; 221/38; 242/160.4; 242/564.4

(57) ABSTRACT

A strip of wipe material in a folded state or wound on a reel and which may or may not be pre-cut, is dispensed by a dispensing machine and has, along its entire length, at least one marking area which gives it a notched appearance on both sides due to a succession of projections and indentations. The marking area defines a shape capable of cooperating with the machine for dispensing wipe materials. The machine includes a load mechanism having a drive with a surface having a matching shape to allow, after meshing, dispensing of the strip of material.

The invention relates to the technical field of machines for dispensing wipe materials, toilet paper and other hygiene and sanitation applications or industrial uses. Said strips of material are wound on a reel or are folded and may or may not be pre-cut. The dispensing machines may or may not provide automatic cutting.

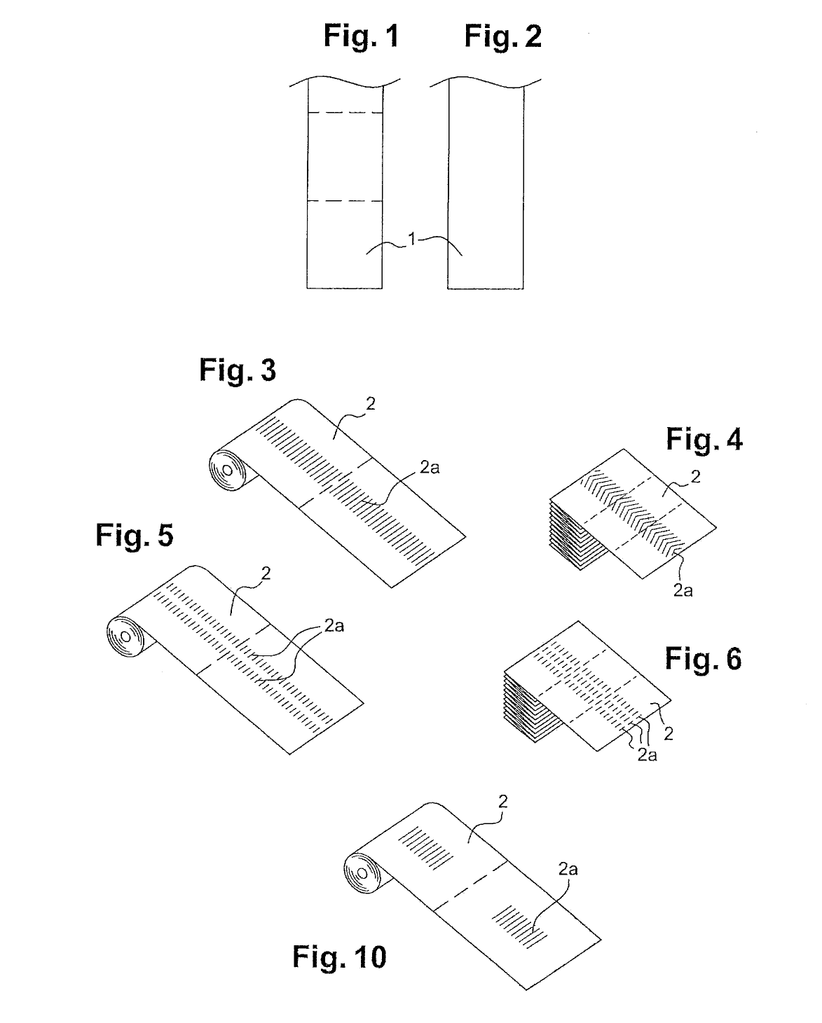

The problem encountered is as follows. The strips (1) of material have a smooth configuration (FIGS. 1 and 2) and can be used in any type of machine, including machines which are manufactured and designed by companies other than those who manufacture and supply the wipe material wound on the reel or in folded form. In other words, this means there is no link between the various parties involved, thus making it possible for a third party to use a given dispensing machine with any strip of wipe material obtained from various sources as dictated by fluctuating prices and supply constraints. This situation is especially detrimental to dispensing machine manufacturers, given the considerable investment involved in researching and designing the moulds used to manufacture said dispensing machines.

In order to control the supply of wipe materials wound on a reel or in folded form, manufacturers have sought to devise more or less complex solutions to ensure that only certain types of wipe material can be dispensed by their dispensing machines. This is the case, for instance, with materials that are wound on a reel and which involve the use of end fittings placed in material support cores. However, these end fittings can be removed and can be refitted in cores which accommodate wipe material wound on a reel obtained from a different source. The Applicant has also conducted research to ensure that, after the reel of wipe material has been exhausted, its end fitting is rendered unusable by destroying its end tip. Technically speaking, such solutions actually work and can be implemented but make the dispensing machine more complex and entail additional costs.

The Applicant has over 40 years of experience in this special field of wipe materials, has filed a very large number of patents and adopted the approach of examining the problem from the viewpoint of the actual wipe material itself rather than the dispensing machine or the end fittings.

Also, from the prior art, one is familiar with U.S. Pat. No. 4,213,363 which also belongs to the Applicant and makes provision for a drum with a rough surface in order to transport the strip of material.

Patent EP 1391174 also discloses how to produce figures marked on a strip of material in order to obtain a visual effect.

French patent No. 2914170 proposes a fibrous cellulose reel with sheets made with individual folds that are connected by bonding or mechanical pressure in order to obtain a non-rigid material. The sheets have patterns.

The solution devised by the Applicant is simple and solves the original objectives of the problem in question, which is to link the characteristics of the actual strip of material to its method of dispensing.

According to a first aspect, the strip of wipe material which is in a folded state or wound on a reel and may or may not be pre-cut and is intended to be dispensed by a dispensing machine is distinctive in that it has, along its entire length, at least one marking area which gives it a notched appearance on both sides due to a succession of protrusions and indentations, said marking area defining a shape capable of cooperating with said wipe material dispensing machine which includes a loading mechanism with a drive means having a surface with a matching shape to allow, after meshing, dispensing of said strip of material, and in that the marking area on the strip of material and the drive means act and cooperate to fulfil a mechanical drive function.

According to another aspect of the invention, the strip of material comprises a continuous marking area over all or part of the width of the strip.

According to another aspect of the invention, the strip of material comprises a discontinuous marking area over all or part of the width of the strip.

These aspects and others will become apparent from the rest of the description.

The invention is explained below in greater detail, reference being made to the accompanying drawings in which:

FIGS. 1 and 2 are schematic views of pre-cut and non pre-cut strips of material according to the prior art (smooth).

FIG. 3 is a view of a strip of wound, pre-cut wipe material according to the invention with a first configuration of the marking area.

FIG. 4 is a view of a strip of folded, pre-cut wipe material according to the invention with a second configuration of the marking area.

FIGS. 5 and 6 are alternative views of the marking area with other configurations.

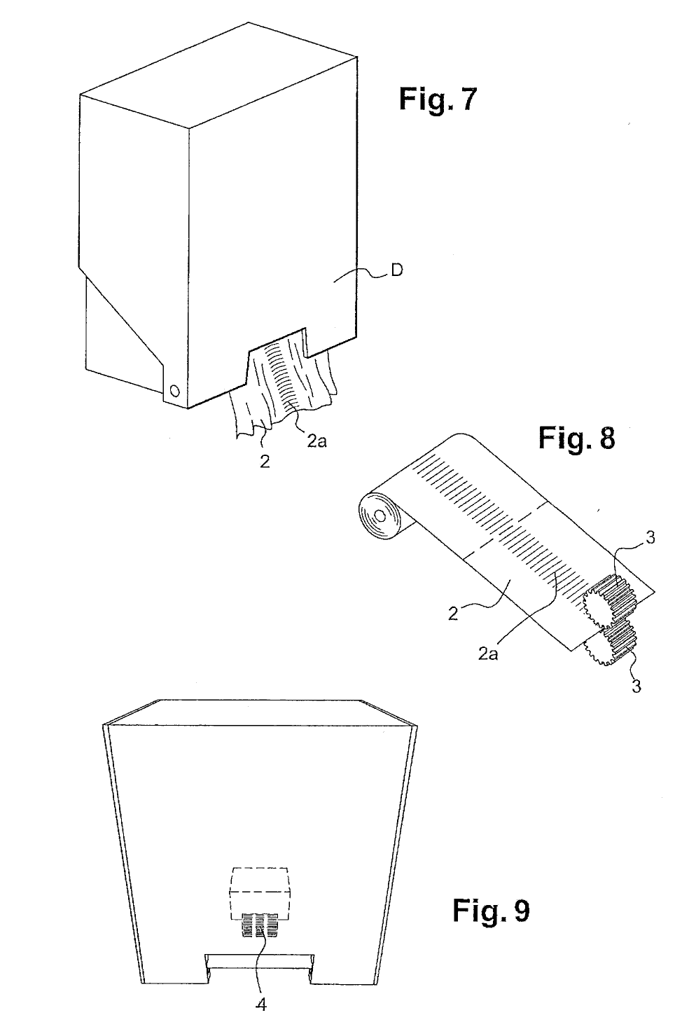

FIG. 7 is a view of a wipe material dispensing machine designed according to the invention.

FIG. 8 is a schematic view showing formation of the marking area during manufacture of the strip of material.

FIG. 9 is a schematic view showing the insertion, into the wipe material dispensing machine, of a loading mechanism equipped with a means of driving the strip of material according to the invention and having a shape that matches the marking area made on said strip of material.

FIG. 10 is an alternative view in which the strip of material comprises a discontinuous marking area.

In order that the object of the invention may more readily be understood, the following description is given, merely by way of example, reference being made to the accompanying drawings.

The strip of wipe material according to the invention is referred to as (2). This strip of material is used for hand-wipes, general-purpose wipes, toilet paper and, generally speaking, all sanitation and hygiene or industrial use applications. It is packaged in reels with or without pre-cutting or in a folded state with or without pre-cutting. This strip is intended to be dispensed by a dispensing machine which may or may not operate with automatic cutting, depending on the packaging configuration (reel or folded).

According to the invention, said strip of material (2) has, along its entire length, at least one marking area (2a) over all or part of the width of the strip and preferably in its central part. The marking area (2a) has, on both sides, a notched appearance due to a succession of projections and indentations capable of defining a wide variety of marking configurations. FIGS. 3 to 6 illustrate, merely by way of example and not exhaustively, simple shapes, e.g. the shape in FIG. 3, a ladder shape in FIG. 4, herringbone shapes in FIGS. 5 and 6 formed in a double or triple ladder. It is thus possible to have bumps or protruding shapes.

Other shapes that represent figurative symbols, logos or other possibly customised shapes can be obtained. The marking area is produced at the time the strip of material is manufactured and packaged by winding or folding by inserting said strip between two marking rollers (3) designed with the marking shape and therefore the desired matching imprints. The two rollers (3) print the marking area as an embossed and indented pattern. The strip of wipe material according to the invention is obtained by embossing.

The strip of material (2) may have a continuous marking area, as shown in FIGS. 3 to 6, or a discontinuous marking area as shown in FIG. 10.

In this embodiment shown in FIG. 10, the marking imprint is produced in a discontinuous, regular manner. This has the particular advantage that, when the strip of material is wound on a reel, it enables the imprint areas to fit into each other, thus significantly reducing the volume of the reel.

The strip of material according to the invention is designed to be dispensed by a wipe material dispensing machine which includes a mechanism for loading the strip of material and comprises a drive means (4) having a surface with a shape that matches the notched area of the strip in order to transport and dispense it. Means (4) is arranged in the machine on any support in any appropriate manner.

Thus, marking area (2a) provided, continuously or discontinuously, on the strip of material and drive means (4) act and cooperate to fulfil a mechanical drive function of the rack gear type.

The advantages are readily apparent from the description.

The strip of material thus designed with its marking area(s) is only capable of being dispensed by a dispensing machine equipped with a drive means having a configuration which is identical and matches that produced on the strip of material in order to allow meshing, thereby allowing the strip to be transported and to emerge from the dispensing machine. A strip of material that is not marked cannot be dispensed.

The configuration of the marking area is arbitrary and can be customised as required.

1. Strip of wipe material and machine for dispensing the strip for use as hand wipes, general-purpose wipes and other hygiene applications, wherein the strip of wipe material is in a folded state or wound on a reel and may or may not be pre-cut and has, along an entire length of the strip, at least one marking area which gives it a notched appearance on both sides due to a succession of protrusions and indentations, said marking area defining a shape that cooperates with said wipe material dispensing machine, and the machine includes a loading mechanism with a drive means having a surface with a shape that matches the protrusions and indentations of said marking area to allow, after meshing of the drive means with the at least one marking area, dispensing of said strip of material, and wherein the at least one marking area on the strip of material and the drive means act and cooperate to fulfill a mechanical drive function.

2. Strip of material and machine as claimed in claim 1, wherein the at least one marking area comprises a continuous marking area over all or part of a width of the strip.

3. Strip of material and machine as claimed in claim 1, wherein the at least one marking area comprises a discontinuous marking area over all or part of a width of the strip.

4. Strip of material and machine as claimed in claim 2, wherein the at least one marking area is located in a central part of said strip.

5. Strip of material and machine as claimed in claim 1, wherein the at least one marking area comprises an embossing.

6. Strip of material and machine as claimed in claim 1, wherein the drive means is provided with a surface having a shape that matches the shape of the marking area on the strip of wipe material.

7. Strip of material and machine as claimed in claim 3, wherein the at least one marking area is located in a central part of said strip.
